(19) United States
(12) Patent Application Publication
(10) Pub. No.: US 2024/0344382 A1
(43) Pub. Date: Oct. 17, 2024

(54) SYSTEM AND METHODS FOR SECURELY RECEIVING DELIVERED PACKAGES THROUGH A DOOR PANEL

(71) Applicant: MARTIN REYES, ANTHONY, NM (US)

(72) Inventor: MARTIN REYES, ANTHONY, NM (US)

(21) Appl. No.: 18/134,175

(22) Filed: Apr. 13, 2023

(51) Int. Cl. E05F 15/73; E05F 15/60; G07C 9/20; G08B 21/18

(52) U.S. Cl. CPC E05F 15/73; A47G 29/12; G07C 9/32; G08B 21/18; E05Y 2800/71

(57) ABSTRACT

A package delivery system can include an electromechanically operable compartment door installed on a door panel (e.g., garage or front door) at a premises. The system can communicate with a control panel mounted near the door panel, which can be configured to scan package information or receive codes from a delivery person/third party. The control panel can authenticate the package information/codes received from the person before operating the compartment door, providing a secure opening for package delivery. The system can send alerts to the owner of the premises when a package is delivered into the garage. The control panel can store a log of package deliveries and receive package delivery instructions from the premises owner. This package delivery system offers a secure and convenient solution for package delivery, ensuring that packages are delivered safely and efficiently. System lights can indicate the presence of a package within the door panel.

### BACKGROUND

With the rise of e-commerce, the number of packages delivered to homes has increased significantly. However, this convenience comes with the risk of package theft. In recent years, there has been a significant increase in the number of packages stolen from doorsteps or front porches. This issue not only results in financial losses for customers and retailers, but it also affects customer satisfaction and trust. Despite various measures, such as surveillance cameras and package lockers, package theft remains a significant problem. Therefore, there is a need for innovative solutions that can provide secure and reliable package delivery to homes.

### SUMMARY OF THE EMBODIMENTS

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

The present invention relates to a package delivery system for a premises that can be integrated within a panel of a door, such as a garage door or front door, to a premises, that includes an electromechanically operable compartment door installed on the door panel.

It is a feature of the embodiments to provide a system can be configured to receive packages into an opening revealed by the electromechanically operable compartment door and through the garage or front door without opening the garage door or front door, providing a more secure and convenient solution receive packaged and to prevent package theft.

In accordance with a feature of the embodiments, an electromechanically operable compartment door installed on a door panel can be in wired or wireless communication with a control panel mounted near the door.

In accordance with another feature of the embodiments, the control panel can be configured to scan package information or receive codes from a delivery person.

In accordance with yet another feature of the embodiments, the control panel is also capable of authenticating the package information or codes received from the delivery person before operating the compartment door to provide a secure opening for package delivery.

In accordance with another feature of the embodiments, the system can further include a notification system that can send an alert to the owner of a premises associated with the garage door or front door when a package is delivered into premises via the door.

In accordance with another feature of the embodiments, at least one of the electromechanically operable compartment door or control panel can be equipped with lights to indicate the presence of a package provided through the compartment door into the premises (e.g., just within the garage or within the front door).

In accordance with another feature of the embodiments, the control panel can be capable of storing a log of package deliveries for review by the owner of the premises, and receiving and storing package delivery instructions from the owner of the premises, including authorized delivery times and delivery personnel.

In accordance with another feature of the embodiments, a method can be enabled with the system wherein a deliver person can scan package information with or receiving codes at a control panel, the package information or codes can be verified by the system, the electromechanically operable compartment door can be electromechanically operated to provide a secure opening within the door panel for receiving the package delivered by the delivery person if the package information or codes have been properly verified. The delivery person can insert the package into the premises through the opening provided by the compartment door. After the package is received the compartment door can automatically close. The owner of the premises can be notified via data network communication that a package has been delivered.

It will be appreciated after reading the patent specification and claims that the embodiments disclosed herein offer a secure and convenient solution for package delivery into premises via an electromechanical compartment door installed within a garage door or front door panel, ensuring that packages are delivered safely and efficiently.

These and other aspects of the embodiments will become more apparent in light of the detailed specification and drawings that follow.

### BRIEF SUMMARY OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates premises with a package delivery system that can be integrated within a panel of a garage door to the premises, that includes an electromechanically operable compartment door installed in the door panel, in accordance with the embodiments;

FIG. 2 illustrates a premises with a package delivery system that can be integrated within a panel of a a front door to the premises, that includes an electromechanically operable compartment door installed in the door panel, in accordance with the embodiments;

FIG. 3 illustrates a front right perspective of a control panel that can be used for a package delivery system, in accordance with the embodiments;

FIG. 4 illustrates another front right perspective of a control panel that can be used for a package delivery system, in accordance with the embodiments;

FIG. 5 illustrates a schematic diagram of various components that can be implemented in a package delivery system, in accordance with the embodiments;

FIG. 6 illustrates a flow diagram of a process for setting up a package delivery system, in accordance with the embodiments; an

FIG. 7 illustrates a flow diagram of a process for using a package delivery system, in accordance with the embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other issues, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

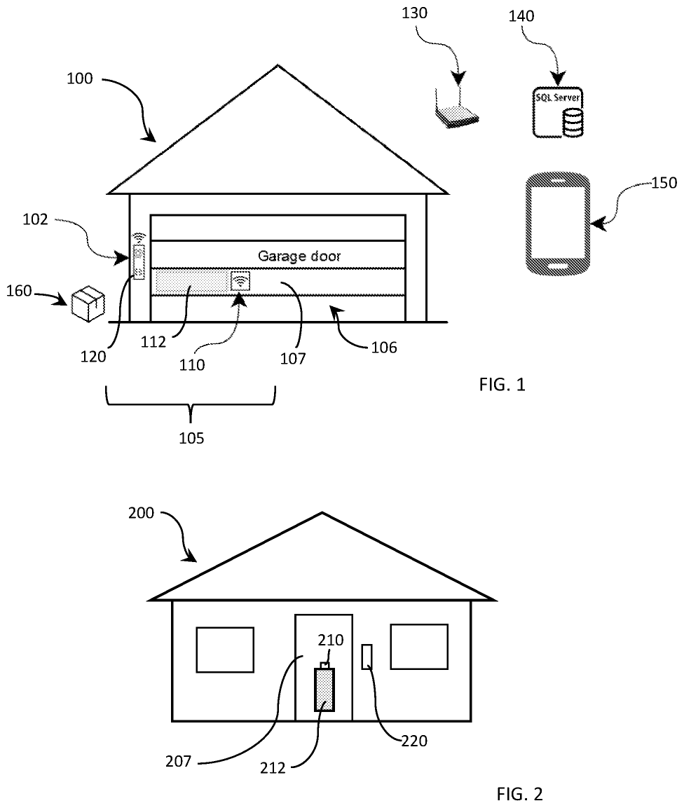

Referring to FIG. 1, illustrated is a premises 100 with a package delivery system 105 that can include a electromechanically operable compartment door 112 that can be installed on a panel 107 of a garage door 106 associated with the premises 100, in accordance with the embodiments. The package delivery system 105 can include control electronics 110 for directly controlling the electromechanically operable compartment door 112. The control electronic 110 can be responsive to a controller 120 that can be accessed outside the premises by users such as package delivery workers. The electromechanically operable compartment door 112 can be in wired or wireless communication with the control panel 120, which can be mounted near the garage door 106. As shown in FIG. 1, the control panel is mounted and located on an exterior wall located near the garage door 106. It should be appreciated that other mounting location are possible, however a location closest to the operable compartment door 112 would likely be preferred. During operation, the control panel 120 can provide a wired or wireless signal to control electronics 110 associated with the electromechanically operable compartment door 112. A command can be to “open” the electromechanically operable compartment door 112 so that a package 160 can be placed through an opening created in the panel 107 once the electromechanically operable compartment door 112 is fully opened. The package 160 can be placed on the floor inside the garage within the garage door because of this functionality.

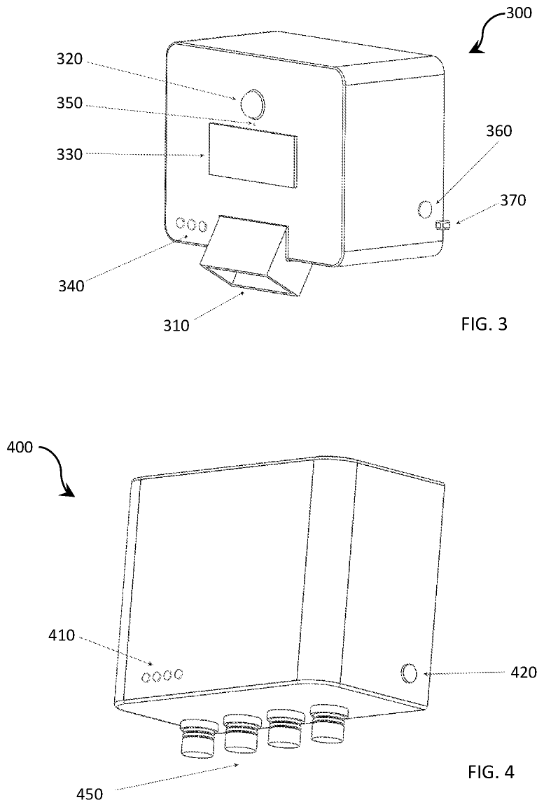

It should be appreciated that the control panel can include a user interface for interaction with the package delivery system 105. The control panel can include image scanner, microphones, speakers, a screen, indicator lights, and can be provided with power from the premises or an integrated solar cell. The control panel is described in more detail in FIG. 3. Also shown in FIG. 1 is a wireless router 130, a database 140 and a mobile device 150. Wireless communications for the package delivery system 105 can be supported via a wireless router 130 by data communications supplied by the premises 100. Authentication of packages 160 can be obtained through the control panel 120 by accessing a remote database 140 that can contain delivery information. A mobile device 150 used by the premises owner can access the package delivery system 105 or receive communications from the package delivery system 105 whenever packaged are delivered or attempts to access the package delivery system 105 are detected. A delivery person can also access the control panel via a mobile device 150.

Referring to FIG. 2, illustrated as another embodiment is a premises 200 with a package delivery system 210 that can be integrated within a panel 207 associate with a front door to the premises 200, in accordance with the embodiments. The package delivery system 210 can include an electromechanically operable compartment door 212 installed in the door panel 207. Operation of the package delivery system 210 would be similar to the system described in FIG. 1. Packages or deliveries can be authenticated using the control panel 220. If delivery can be accepted, then a signal can be provided to control electronics associated with the electromechanically operable compartment door 212 to open the electromechanically operable compartment door 212.

It should be appreciated from the present teaching that the electromechanically operable compartment door 112/212 cannot remain open. The electromechanically operable compartment door 112/212 can automatically close after a set period of time, after the control electronics or an associated sensor senses that the package has been received, or via control (remote or local) of the control panel 120/220.

Referring to FIG. 3, illustrated is a front right perspective of a control panel 300 that can be used for a package delivery system, in accordance with the embodiments. The control panel 300 can include a camera 320 for recording activity associated with the package delivery system. A microphone 350 can support communications between delivery personnel and a remote premises owner. A screen can provide commands, results and other data to a package delivery person. Indicator lights can represent that the package delivery system, e.g., either control panel 300 and/or the electromechanically operable compartment door 112/212 have been accessed. If it has been accessed, the indicator lights (e.g., a flashing strobe, LED or the like) can indicate that a package is waiting behind the door so that the package 160 is not run over by a vehicle parking in the garage, or tripped over by a premise ownerhing entering the front door to the premises. A scanner 310 can obtain bar codes or other delivery information from a label on a package 160, or credentials from a badge of the delivery person. This information can be compared to a database to confirm the delivery is legitimate and that the electromechanically operable compartment door 112/212 should or can be opened. Power can be connected to the control panel 300 from the premises via a connection 370. Power can also be supplied via a solar panel that can be integrated on the control panel. A configuration button 360 can be provided to provide functions such as resetting the control panel, and power on/off.

Referring to FIG. 4, illustrated is a front right perspective of another control panel 400 that can be used for a package delivery system, in accordance with the embodiments. The control panel 400 that is illustrated can have less external functionality. It can include wireless communications that support interacting with a mobile device 150 as shown in FIG. 1. It can also contain the control electronics 110 supporting direct electromechanically control of the electromechanically operable compartment door 112/212. Indicator lights can function similar to those described in FIG. 3.

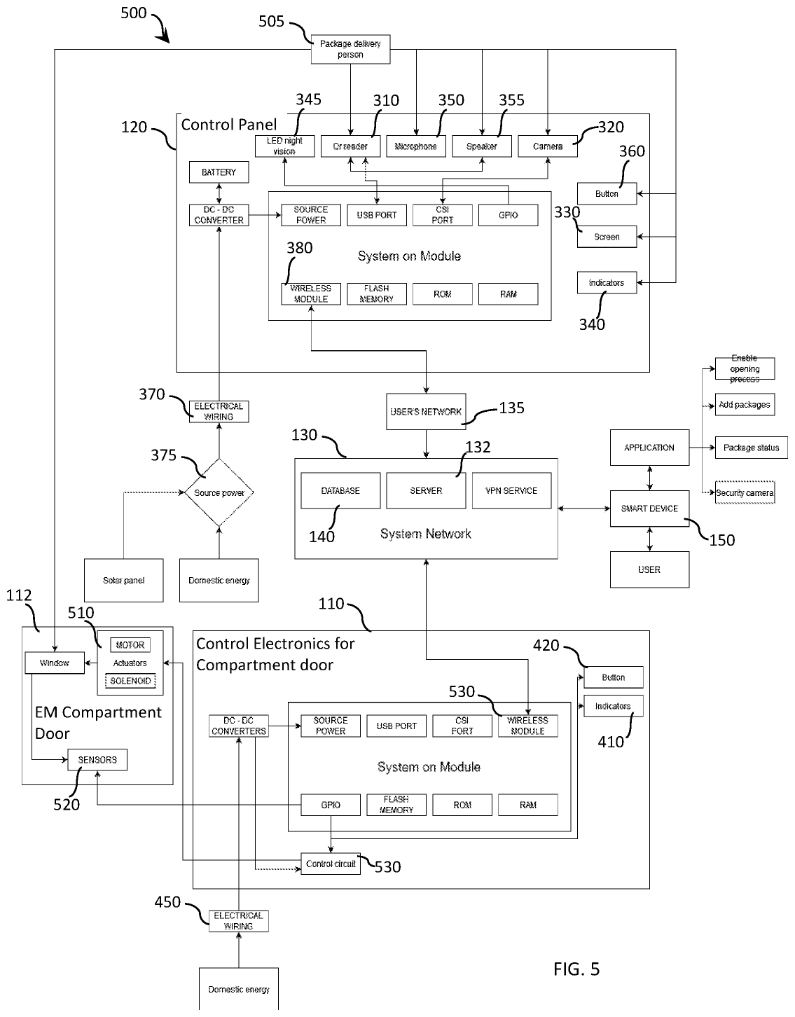

Referring to FIG. 5, a schematic diagram of various components that can be implemented in a package delivery system 500, in accordance with the embodiments. The control panel 120, access control electronics 110 and electromechanically operable compartment door 112 are major modules for the system and can communicate via support of a system network 130. It is the control panel 120 that would typically have direct interaction with a package delivery person 505. A wireless module 380 can support short range and long range data communications. For example, short range communications such as Bluetooth can support communications between the control panel 120 and the access control electronics 110, whereas WiFi can support communications with data communications networks (e.g., Internet, Cellular data) to reach remote resources (e.g., server 132, database 140). Indicators 340 can provide light signals or indications that the system has received interaction or that a package has been delivered and is sitting within the door (e.g., inside the garage or front door depending on implementation). An optical reader 310 (e.g., Qr code reader) can obtain package information or badge/ID information from a delivery person. A microphone 350 and speaker 355 can support further communications between a delivery person and a premises owner that may be remote. A camera 320 can obtain footage of any interaction with the control panel and an area surrounding the package delivery system 500. A screen 330 can provide information to a user of the control panel, such as the package delivery person 505. Other buttons 360 can be provided to provide additional functionality. Electrical wiring 370 can obtain electrical power 375 from the residence or solar panel associated with the control panel 120.

The access control electronics 110 can also include an integral casing, control circuitry 530 needed to operate the system, a wireless communication module 530 that allows continuous communication with a remote database 140, access to a server 132 for video storage coming from the control panel 120, a configuration button 420 and LED indicators 410 on the outer part of the casing, and coupling to an electromechanically operable compartment door 112. The electromechanically operable compartment door 112 can include actuators (e.g., motor, solenoid) to move the electromechanically operable compartment door 112 into open and closed positions.

The Wi-Fi access point 130 can enable the interconnection between the control panel 120, control electronics 110 associated with the electromechanically operable compartment door 112, mobile devices 150, remote servers 132 and remote databases 140. The database 140 can enable authentication of a deliver person as a user or the package label from the control panel 120 or a mobile device 150.

The control panel 120, access control electronics 110 can cooperate to enable the storage of new tracking code information originating from the smart device, validation of the information coming from the console device, and update of information that allows activating the automatic opening process. The smart device 150 (e.g., smartphone or mobile phone) can connect with the system can allow the creation of new users and the assignment of new tracking numbers. The device can also allow the actual status of the tracking numbers in the system to be delivered to the user. On the other hand, the system can allow visualization of video with the camera 320 and store it in server 132.

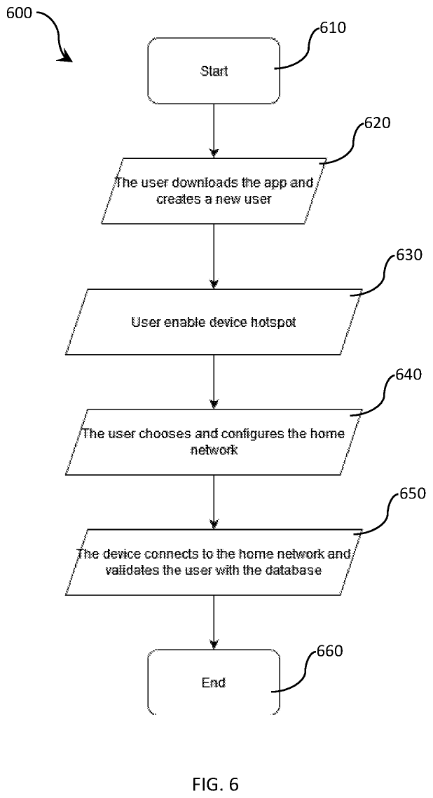

Referring to FIG. 6, illustrated is a flow diagram 600 of a process for setting up a package delivery system 500, in accordance with the embodiments. The process starts at block 610. A user can download the application and create a new user, as shown in block 620. Then as shown in block 630, the user can enable the systems hotspot. Then as shown in block 640, the user configures the system to operate on the home network (e.g., premises network). The device can be connected to the home network and the user is validated via the app with a remote database where initial registration was achieved, as shown in block 650. The process then ends as shown in block 660. The package delivery system 500 is now setup and configured and can begin operation.

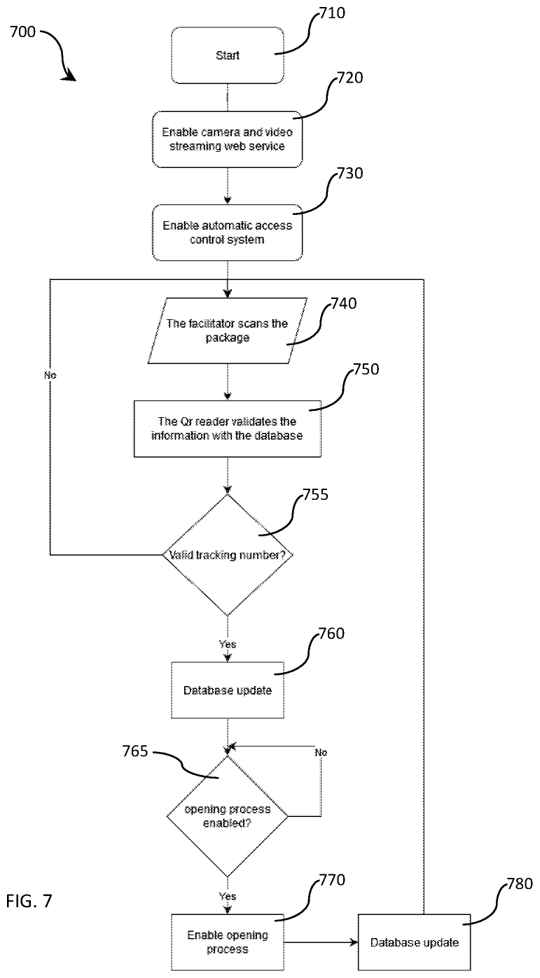

Referring to FIG. 7, illustrated is a flow diagram 700 of a process for using a package delivery system, in accordance with the embodiments. The process can start at block 710. As shown in block 720, camera and video streaming service can be functioning before a user interface with the control panel. As shown in block 730, automatic access to the system can also be achieved by motion detection with the camera or by a user physically touching the control panel (e.g., buttons). As shown in block 740, a facilitator (e.g., delivery person) can scan a package at the control panel. As shown in block 750 a Qr reader sends the image for validation the scanned image with package delivery data in a database. At block 755, it is determined whether the tracking number is valid. If it is not deemed valid the process can be repeated at block 740. It the tracking number is validated, then the database can be updated as shown in block 760. If the package has been delivered or cannot be found in the database, the opening process does not have to commence. Once the Tracking ID has been validated, the control panel can send a signal to the control electronics 110 associated with the electromechanically operable compartment door 112 to begin the opening process, as shown in block 765. By enabling the opening process, block 770, the electromechanically operable compartment door opens so that a package can be placed within an opening revealed by the opened electromechanically operable compartment door 112. The database can once again be updated as shown in block 780 once the package has been placed inside the door. The system can have the capacity to record and send in real time through an internet connection. The configuration button can allow the introduction of the credentials of a local network and the username and password created previously.

When a facilitator (package delivery person) positions the package bar code towards the lector's vision, visual and/or audible indicators can let the facilitator know if the package has been scanned correctly. The console can record continuously and will save all videos locally so the user can view the recordings. Once the package has been scanned, the console can communicate with a database through the data network to validate the guide number and be able to determine if the opening process should begin or it will indicate to the facilitator throughout the indicator that the package is not in the database. If the package is in the database, the console can notify the facilitator that the package has been accepted. The console can cause the system control electronics associated with the electromechanically operable compartment door to begin the opening process and modifies the actual status of the package in the database.

The system contemplates continuous communication between the console and the access box to save the videos recorded by the console. The console can be supplied with electrical power by domestic electrical power or by a solar panel. The user can consult the status of the package from the application, add new tracking numbers and access the camera in real-time. The console contemplates visual and auditive indicators, a microphone, a camera, and LEDs for nocturnal vision. The system can include sensors and actuators that allow closing of a window situated in a garage door after a period of time, after sensing deliver (placement) of the package, remotely by the premises owner, or when a button is pressed by the delivery person. The system can include a storage unit and a wireless communication module that allows continuous communication with the database.

It will be appreciated that variations of the above-disclosed embodiments and examples and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A package delivery system for a premises, comprising:
a door panel associated with the premises including an electromechanically operable compartment door installed therein; and
a control panel mounted near the door panel, configured to communicate wirelessly or through a wired connection with the electromechanically operable compartment door and receive scanned package information or codes from a delivery person;
wherein the control panel is configured to operate the electromechanically operable compartment door to provide a secure opening for the package delivery through the door panel and the electromechanically operable compartment door is configured to automatically close after the package is received through the secure opening.

2. The package delivery system of claim 1, wherein the control panel is configured to authenticate the scanned package information or codes received from a delivery person before operating the electromechanically operable compartment door.

3. The package delivery system of claim 1, wherein the electromechanically operable compartment door is configured to receive packages of various sizes for storage within the door panel.

4. The package delivery system of claim 1, further comprising a notification system configured to send an alert to the owner of the premises when a package is delivered to the premises.

5. The package delivery system of claim 1, wherein the control panel is configured to allow the owner of the premises to remotely operate the electromechanically operable compartment door.

6. The package delivery system of claim 1, wherein at least one of the electromechanically operable compartment door or control panel is equipped with lights to indicate the presence of a package provided through the compartment door and into the premises.

7. The package delivery system of claim 1, wherein the control panel is configured to store a log of package deliveries for review by the owner of the premises.

8. The package delivery system of claim 1, wherein the control panel is configured to receive and store package delivery instructions from the owner of the premises, including authorized delivery times and delivery personnel.

9. The package delivery system of claim 1, wherein the electromechanically operable compartment door is configured to be compatible with or configurable for installation within existing garage door and front door panels.

10. A method of delivering packages to a premises using the package delivery system of claim 1, comprising the steps of:
scanning package information or codes with the control panel;
verifying the package information or codes;
operating the electromechanically operable compartment door to provide a secure opening within at least one of a garage door panel or front door panel for receiving the package delivery;
inserting the package into the premises through the opening provided by the compartment door;
automatically closing the electromechanically operable compartment door after the package is received through the secure opening; and
notifying the owner of the premises that a package has been delivered.

11. A package delivery system for a premises, comprising:
an electromechanically operable compartment door installable on a door panel associated with the premises; and
a control panel mounted near the door panel, configured to communicate wirelessly or through a wired connection with the electromechanically operable compartment door and receive scanned package information or codes from a delivery person, wherein the control panel is configured to operate the electromechanically operable compartment door to provide a secure opening for the delivery person to deliver a package through the door panel.

12. The package delivery system of claim 11, wherein the control panel is configured to authenticate the scanned package information or codes received from a delivery person before operating the electromechanically operable compartment door.

13. The package delivery system of claim 1, wherein the electromechanically operable compartment door is configured to receive packages of various sizes for storage within the door panel.

14. The package delivery system of claim 1, further comprising a notification system configured to send an alert to the owner of the garage when a package is delivered to the premises.

15. The package delivery system of claim 1, wherein the control panel is configured to allow the owner of the premises to remotely operate the electromechanically operable compartment door.

16. The package delivery system of claim 1, wherein at least one of the electromechanically operable compartment door or control panel is equipped with lights to indicate the presence of a package provided through the compartment door and into the premises.

17. The package delivery system of claim 1, wherein the control panel is configured to store a log of package deliveries for review by the owner of the premises.

18. The package delivery system of claim 1, wherein the control panel is configured to receive and store package delivery instructions from the owner of the premises, including authorized delivery times and delivery personnel.

19. The package delivery system of claim 1, wherein the electromechanically operable compartment door is configured to be compatible with or configurable for installation within existing garage door and front door panels.

20. A method for securely receiving delivered packages at a premises, comprising:
providing an electromechanically operable compartment door installable on a door panel associated with the premises and a control panel mounted near the door panel, configured to communicate wirelessly or through a wired connection with the electromechanically operable compartment door and receive scanned package information or codes from a delivery person, wherein the control panel is configured to operate the electromechanically operable compartment door to provide a secure opening for the delivery person to deliver a package through the door panel;
scanning package information with or receiving codes at the control panel;
verifying the package information or codes;
operating the electromechanically operable compartment door to provide a secure opening within the door panel for receiving the package delivered by the delivery person, wherein the delivery person inserts the package into the premises through the opening provided by the compartment door; and
notifying the owner of the premises that a package has been delivered.
